(19) United States
(12) Patent Application Publication
(10) Pub. No.: US 2005/0282484 A1
(43) Pub. Date: Dec. 22, 2005

(54) Method and apparatus for controlling actuator in ventilator for vehicle

(75) Inventor: Yang Young Kim, Cheonju-city (KR)

Correspondence Address: F. CHAU & ASSOCIATES, LLC, 130 WOODBURY ROAD, WOODBURY, NY, 11797, US

(73) Assignee: DONG-AH ELECTRIC COMPONENTS CO., LTD.

(21) Appl. No.: 10/994,122

(22) Filed: Nov. 20, 2004

(30) Foreign Application Priority Data
Jun. 17, 2004 (KR) 2004-45123

(51) Int. Cl. B60H 1/00

(52) U.S. Cl. 454/75

(57) ABSTRACT

A method and apparatus for controlling an actuator in a ventilator for a vehicle, controls an actuator which controls position of a door for a ventilator for a vehicle without having a particular feedback device. The actuator controlling method and apparatus counts the number of spike signals generated by a mechanical contact between a rotator and a brush of an actuator motor to then calculate the number of rotations of the motor and thus controls an actuator until the calculated number of rotations of the motor reaches the number of pulses up to a user's desired target position. Thus, the actuator motor can be accurately controlled without having any separate feedback circuit, to thereby control a door to be positioned at a user's desired position. Further, since a configuration of the actuator is simplified, a production cost can be reduced and control devices can be shared with each other.

### BACKGROUND OF THE INVENTION

1. Field of the Invention

The present invention relates to an actuator for controlling position of a door in a ventilator for a vehicle, and more particularly, to a method and apparatus for controlling an actuator in a ventilator for a vehicle, which detects the number of rotations of a motor without having a particular feedback device and then controls the actuator.

2. Description of the Related Art

An actuator is disposed in a ventilation system for a vehicle and used for opening and closing a door which controls an air flow. That is, an actuator controls position of a vent door for controlling air vent direction, an air mix door for controlling temperature, and an intake door for controlling inner and outer air, in an air ventilator for a vehicle.

In such a vehicle ventilation system, the actuator is configured to include a DC (Direct Current) motor connected with a reduction gear and a lever and a feedback signal generator for detecting position of a regulator. In particular, the feedback signal generator can adopt a voltage varying method using a potentiometer due to a contact variation of a carbon resistor which is printed on a PCB (Printed Circuit Board) of a brush mechanically connected to the actuator reduction gear, or a signal generating method using photodiodes and phototransistors around the rotational axis of the motor. However, since these methods use separate components for feedback in addition to the components for drive, internal circuits become complicated and are increased in cost. Also, since a mechanically separated design is required according to a design of a regulator, devices cannot be shared with each other.

### SUMMARY OF THE INVENTION

To solve the above problems, it is an object of the present invention to provide a method for calculating the number of rotations of a motor from a minute variation of voltage generated by a mechanical contact between a rotator and a brush of the motor and thus controlling an actuator without having any separate feedback signal generator.

It is another object of the present invention to provide an apparatus embodying the method for controlling an actuator in a ventilator for a vehicle.

To accomplish the above object of the present invention, there is provided a method for controlling an actuator in a ventilator for a vehicle, the method comprising the steps of: (a) detecting a spike signal generated by a mechanical contact when a motor in the actuator rotates; (b) calculating the number of rotations of the motor from the detected spike signal; and (c) controlling the actuator according to the calculated number of rotations to control a door to be at a desired position.

There is also provided an apparatus for controlling an actuator in a ventilator for a vehicle, the apparatus comprising: an actuator having only a DC motor connected with a reduction gear and a lever; a motor drive which drives the motor in the actuator; a sensing resistor connected in series to the motor and detecting voltage applied across the motor; a pulse generator which detects a predetermined spike signal loaded in a motor voltage signal detected by the sensing resistor and generates a rectangular pulse; and a microcontroller which determines a forward/reverse rotational direction of the motor according to a target point of the door and sends a motor drive signal to the motor drive, to thereby control the actuator, and counts the number of the rectangular pulses generated from the pulse generator to thereby calculate the number of rotations of the motor to thus control the actuator to then control the door to be at a desired position.

### BRIEF DESCRIPTION OF THE DRAWINGS

The above and other objects and advantages of the present invention will become more apparent by describing the preferred embodiments thereof in detail with reference to the accompanying drawings in which:

FIG. 1 shows waveforms illustrating a spike signal which is generated for one rotation of a motor in an actuator;

FIG. 2 is a block diagram showing an apparatus for controlling an actuator for a vehicle according to the present invention;

FIG. 3 is a detailed block diagram showing a pulse generator of FIG. 2;

FIG. 4 shows waveforms illustrating an operation of each component of FIG. 3; and

FIG. 5 is a flowchart view for explaining a method for controlling an actuator for a vehicle according to the present invention.

### DETAILED DESCRIPTION OF THE INVENTION

A preferred embodiment of the present invention will be described with reference to the accompanying drawings.

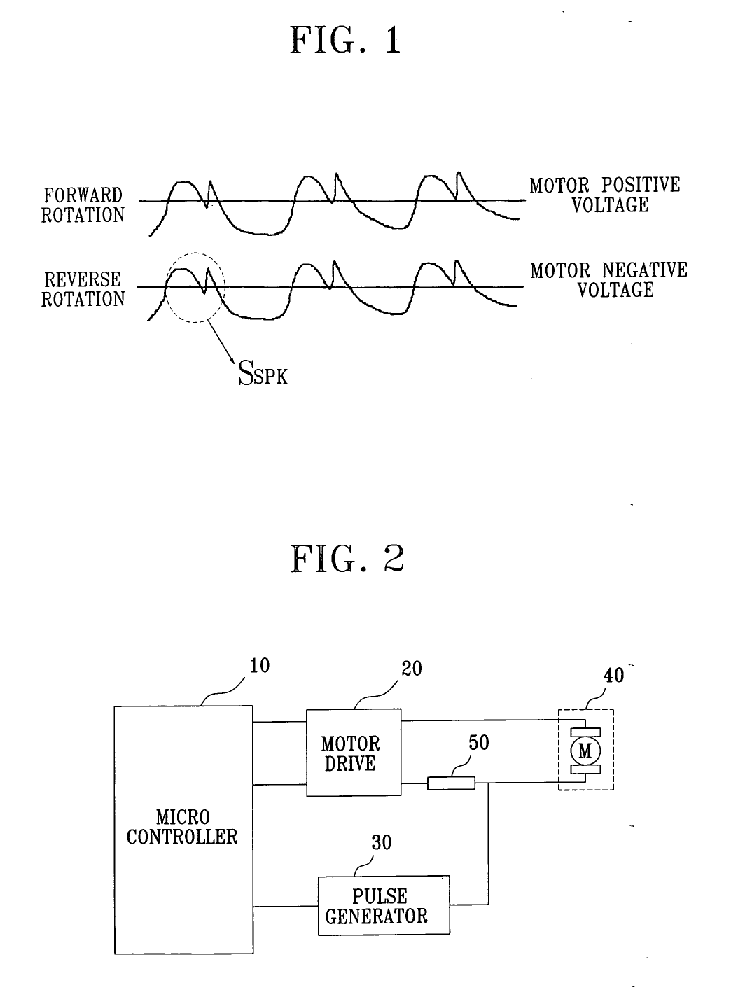

In general, a DC motor includes a stator made of a permanent magnet, a rotor made of wound coil, and a commutator applying current to the rotor coil. In particular, the commutator and a power source terminal supplying current for the commutator electrically contact through a brush. When electric power is applied to the motor, current flows through the rotor coil so that the motor rotates and the brush and the rotor alternately electrically contact to each other. Here, as shown in FIG. 1, a minute spike signal Sspk is generated in the voltage applied across both ends of the motor due to the mechanical contact of the motor. In the case of the motor used in the actuator, the number of windings of coil is three and thus if three spike signals are counted, the motor rotates one cycle. The present invention uses the property of the motor to properly control the number of rotations of the motor, to thereby control the actuator to have a door positioned at a desired position.

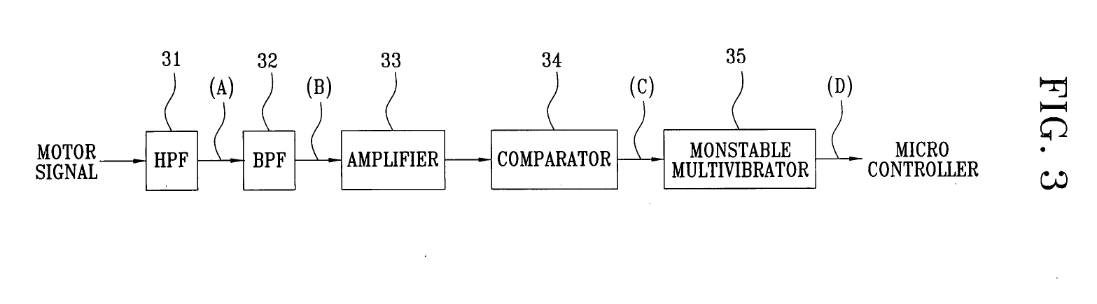

FIG. 2 is a block diagram showing an apparatus for controlling an actuator for a vehicle according to the present invention. The actuator controlling apparatus shown in FIG. 2 includes an actuator 40 in which a DC motor M rotating forwardly/reversely according to applied voltage is mounted, and a motor drive 20 supplying positive/negative voltage to the motor M for the actuator 40 and driving the motor M forwardly/reversely. Here, the actuator 40 is mounted with only a DC motor M connected with a reduction gear and a lever without having any particular feedback circuit. The actuator controlling apparatus of FIG. 2 also includes a sensing resistor 50 which detects voltage applied across the motor M and a pulse generator 30 which detects a spike signal (refer to the “Sspk” waveform of FIG. 1) loaded on the detected voltage and thus generates a rectangular pulse corresponding to the detected spike signal. The detailed configuration of the pulse generator 30 will be described with reference to FIG. 3. Meanwhile, the actuator controlling apparatus of FIG. 2 includes a microcontroller 10 which drives the motor drive 20 according to user's manipulation, counts the number of the rectangular pulses generated in the pulse generator 30 to thereby calculate the number of rotations of the motor M, and controls the actuator 40 according to the calculated number of rotations of the motor M.

FIG. 3 is a detailed block diagram showing the pulse generator 30 of FIG. 2. The pulse generator 30 shown in FIG. 3 includes a high pass filter (HPF) 31 which filters the signal detected in the motor M in the actuator 40 and removes a DC components and a band pass filter (BPF) 32 which filters a motor signal having exerted a high pass filtering operation and detects only a spike signal which is a high frequency component. The pulse generator 30 shown in FIG. 3 also includes an amplifier 33 which amplifies the signal having passed through the high pass filter and the band pass filter in turn into a predetermined magnitude, a comparator 34 which makes the amplified signal of the predetermined magnitude into a rectangular pulse, and a monostable multivibrator 35 which generates a stable rectangular pulse having a predetermined period with the rectangular pulse made in the comparator 34.

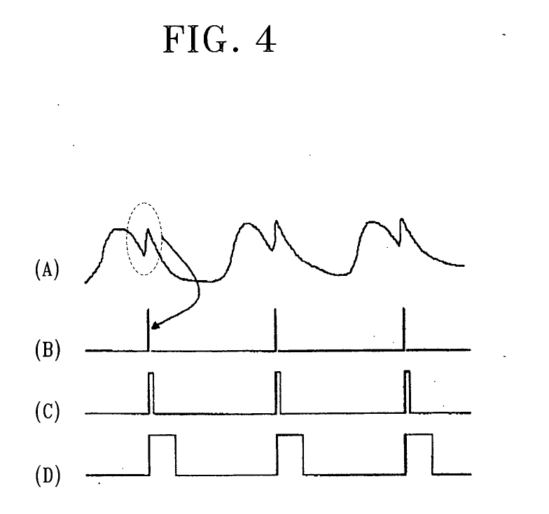

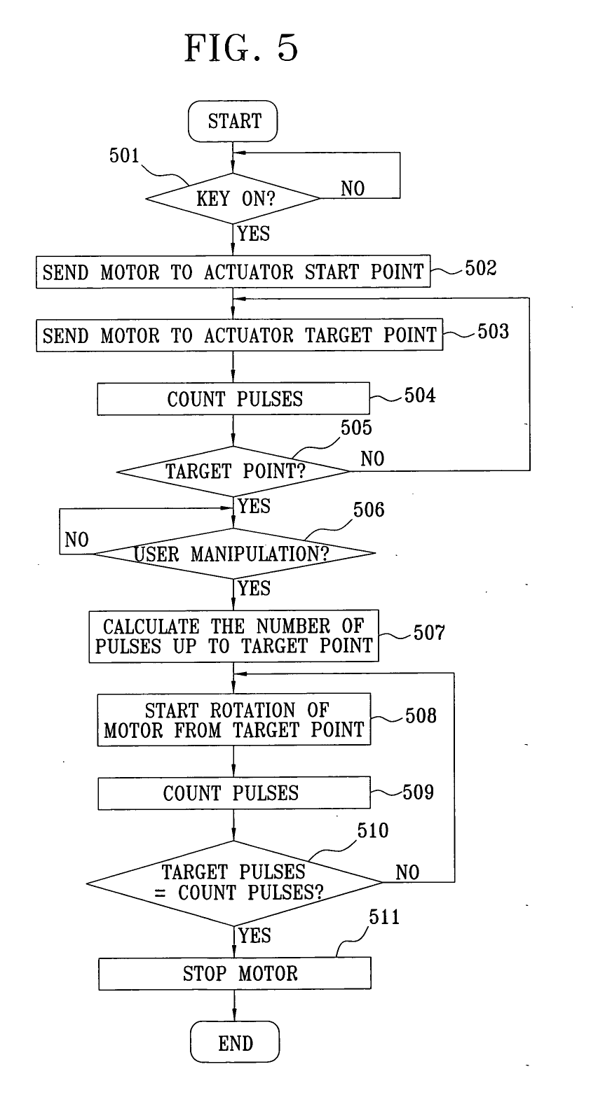

The operation of the apparatus for controlling an actuator in a ventilator for a vehicle according to the present invention will be described in more detail with reference to FIGS. 4 and 5.

If a vehicle driver rides on a car and turns on the car with a key (step 501), each actuator 40 executes correction. This is to prevent a pulse error from being accumulated due to external disturbance. For this, the microcontroller 10 drives the motor drive 20 to then have the motor M rotate to a starting point of a door with the actuator 40 (step 502). Then, the microcontroller 10 controls the actuator 40 to a stored position, that is, a door position when the car is turned off (hereinbelow referred to as a previous target point) (step 503). The microcontroller 10 drives the motor drive 20 as many as the number of rotations of the motor M corresponding to the stored target point to then make the motor M in the actuator 40 rotate. A corresponding door is position at the previous target point according to rotation of the motor M. Here, the pulse generator 30 generates a rectangular pulse which can be processed in the microcontroller 10 from the spike signal Sspk of FIG. 1 which is loaded on the signal of the motor M in the actuator 40 which is detected by the sensing resistor 50. The microcontroller 10 counts the number of the rectangular pulses generated in the pulse generator 30 (step 504), and calculates the number of rotations of the motor M from the count value, to thereby judge whether or not the door is positioned at the previous target point (step 505). Here, since three spike signals, that is, three pulses are generated whenever the motor rotates one cycle, a resolution of 120 degrees is obtained. If the microcontroller 10 judges that the door is positioned at the previous target point in step 505, it controls the motor drive 20 to stop to then stop the rotation of the motor M in the actuator 40. If the microcontroller 10 judges that the door is not positioned at the previous target point in step 505, it repeats the following steps from step 503.

If the correction for each actuator 40 is completed through the above-described process, the microcontroller 10 judges whether or not a user manipulates (step 506). That is, if a driver manipulates switches (not shown) in the vehicle ventilation system and drives a door actuator 40, the microcontroller 10 calculates the number of pulses up to a target point which is newly set by user manipulation (step 507), and then starts rotation of the motor M up to the target point (step 508). The microcontroller 10 determines forward/reverse rotation of the motor M and drives the motor drive 20. The motor drive 20 drives the motor M under the control of the microcontroller 10 and applies predetermined positive/negative voltage to the motor M in the actuator 40. The motor M in the actuator 40 rotates forwardly/reversely according to the predetermined positive/negative voltage applied from the motor drive 20, in order to regulate position of the door. Here, the sensing resistor 50 connected in series to the motor M detects the voltage applied across the motor M. The voltage is detected at an applied voltage level when the motor M rotates forwardly, and at a ground level when it rotates reversely. As shown in FIG. 1, the voltage detected in the sensing resistor 50 has a pattern in which a spike signal is loaded on a DC component signal. The pulse generator 30 receives the signal detected in the sensing resistor 50, filters through a high pass filter (HPF) 31 to remove a DC component, and detects only a spike signal of an AC component shown as a waveform (A) in FIG. 4. Here, the waveform (A) of FIG. 4 obtained by having passed through the high pass filter (HPF) 31 is a signal including both a high frequency signal and a low frequency signal. The pulse generator 30 filters the waveform (A) of FIG. 4 output from the high pass filter (HPF) 31 through a band pass filter (BPF) 32 having a frequency pass band of 45 MHz to 55 MHz, in order to remove a low frequency component and detect only a spike signal of a high frequency component shown as a waveform (B) of FIG. 4. However, since the waveform (B) of FIG. 4 is a signal of a minute voltage level which is difficult to process it in the microcontroller 10, the pulse generator 30 amplifies the waveform (B) of FIG. 4 into a predetermined magnitude via an amplifier 33. Then, a rectangular pulse shown as a waveform (C) of FIG. 4 is made via the comparator 34 in order to convert the analog signal into a digital signal. However, since the rectangular pulse shown as the waveform (C) of FIG. 4 is a signal having a very short period, it is generated as a stable rectangular pulse having a predetermined period shown as a waveform (D) of FIG. 4 via the monostable multivibrator 35 so as to be recognized in the microcontroller 10, to then be applied to the microcontroller 10.

The microcontroller 10 counts the number of the rectangular pulses shown as the waveform (D) of FIG. 4 generated in the pulse generator 30 (step 509). The microcontroller 10 checks whether or not the count value reaches the number of the pulses at the previously calculated target point (step 510). In the result of checking, if the count value does not reach the target number of pulses, the microcontroller 10 repeats the following steps from step 508. If the count value reaches the target number of pulses, the microcontroller judges that the door is positioned at a target point, and stops the motor drive 20 from being driven, to thereby make the motor M stop (step 511).

As described above, the method and apparatus for controlling an actuator in a ventilator for a vehicle according to the present invention calculates the number of rotations of a motor from a minute variation of voltage generated by a mechanical contact between a rotator and a brush of the actuator motor and thus controls an actuator to be positioned at a desired position without having any separate feedback signal generator. Further, since only a DC motor is mounted in the actuator, a production cost can be reduced and control devices can be shared with each other.

1. A method for controlling an actuator in a ventilator for a vehicle, the method comprising the steps of:
(a) detecting a spike signal generated by a mechanical contact when a motor in the actuator rotates;
(b) calculating the number of rotations of the motor from the detected spike signal; and
(c) controlling the actuator according to the calculated number of rotations to control a door to be at a desired position.

2. The actuator controlling method according to claim 1, wherein said spike signal detecting step (a) comprises the sub-steps of:
(a1) if a target point of the door is set by user's manipulation, calculating the number of pulses up to the set target point;
(a2) making the motor in the actuator rotate and detecting voltage applied across the rotating motor;
(a3) filtering the detected voltage signal of the motor and detecting only the spike signal; and
(a4) amplifying the detected spike signal into a level of a predetermined magnitude and then outputting a rectangular pulse.

3. The actuator controlling method according to claim 2, wherein in said sub-step (a3), the detected voltage signal of the motor is high pass filtered to remove a DC component, and then the signal from which the DC component signal has been removed is passed through a band pass filter to detect only a spike signal which is a high frequency component.

4. The actuator controlling method according to claim 1, wherein said motor rotational number calculating step (b) comprises the sub-steps of:
counting the detected spike signal; and
calculating the number of rotations of the motor from the count value based on the number of the spike signal generated per one rotation of the motor.

5. The actuator controlling method according to claim 2, wherein said motor rotational number calculating step (b) comprises the sub-step of counting the number of the rectangular pulses.

6. The actuator controlling method according to claim 5, wherein said door controlling step (c) comprises the sub-steps of:
judging whether or not the number of the counted pulses reaches the number of pulses at the calculated target point; and
controlling the motor to stop if the former reaches the latter, and to rotate if not.

7. The actuator controlling method according to claim 1, wherein a correction for making the motor rotate up to a starting point of the door and then making the motor rotate up to a stored previous target point of the door is executed through the steps in advance, in order to prevent a pulse error from being accumulated due to the external disturbance of the motor when a motor car is started.

8. An apparatus for controlling an actuator in a ventilator for a vehicle, the apparatus comprising:
an actuator having only a DC motor connected with a reduction gear and a lever;
a motor drive which drives the motor in the actuator;
a sensing resistor connected in series to the motor and detecting voltage applied across the motor;
a pulse generator which detects a predetermined spike signal loaded in a motor voltage signal detected by the sensing resistor and generates a rectangular pulse; and
a microcontroller which determines a forward/reverse rotational direction of the motor according to a target point of the door and sends a motor drive signal to the motor drive, to thereby control the actuator, and counts the number of the rectangular pulses generated from the pulse generator to thereby calculate the number of rotations of the motor to thus control the actuator to then control the door to be at a desired position.

9. The actuator controlling apparatus according to claim 8, wherein said spike signal is generated due to a mechanical contact when the motor in the actuator rotates, in which the number of the spike signals are generated per one rotation of the motor as many as the number of coil windings of a rotor in the motor.

10. The actuator controlling apparatus according to claim 8, wherein said sensing resistor detects voltage applied across the motor at the applied voltage level at the time of the forward rotation of the motor in the actuator, and detects voltage applied across the motor at the ground level at the time of the reverse rotation of the motor.

11. The actuator controlling apparatus according to claim 9, wherein said pulse generator comprises:
a filter which filters the motor voltage signal detected by the sensing resistor and detects only a spike signal;
an amplifier which amplifies the spike signal level detected in the filter into a predetermined magnitude;
a comparator which converts the level amplified spike signal into a rectangular spike signal; and
a monostable multivibrator which generates a stable rectangular pulse having a predetermined period from the rectangular spike signal so as to be recognized in the microcontroller.

12. The actuator controlling apparatus according to claim 11, wherein said filter comprises:
a high pass filter which removes a DC component of the motor voltage signal detected in the sensing resistor; and
a band pass filter having a frequency pass band of 45 MHz to 55 MHz, which detects only a spike signal of a high frequency signal from the motor voltage signal from which the DC component signal has been removed.
